(19) United States
(12) Patent Application Publication
(10) Pub. No.: US 2018/0108088 A1
(43) Pub. Date: Apr. 19, 2018

(54) TARGETED SECURITY TRADE INVITATIONS

(71) Applicant: Liquidnet Holdings, Inc., New York, NY (US)

(72) Inventors: Natasha Shamis, Merrick, NY (US); Thomas D'Eletto, Maplewood, NJ (US); Bobby Rahman, South Woodford (GB); Antony James Booth, Harpenden (GB)

(21) Appl. No.: 15/784,551

(22) Filed: Oct. 16, 2017

Related U.S. Application Data
(60) Provisional application No. 62/409,553, filed on Oct. 18, 2016.

(51) Int. Cl. G06Q 40/04; G06Q 40/06; G06Q 30/06; G06F 3/048

(52) U.S. Cl. CPC G06Q 40/04; G06F 3/048; G06Q 30/0607; G06Q 40/06

(57) ABSTRACT

In a method of facilitating a trade of a security in an electronic trading system, a graphical user interface (GUI) is displayed on a display device of the system, and order characteristics are received that define a candidate order for a security. A selectable element is displayed on the GUI that creates a targeted invitation, and a notification is sent to one or more candidate members of the trading system in response to the selection of the selectable element. An answer to the notification is received. In response to receiving the answer, a trade of at least a portion of the candidate order is executed, the execution of the candidate order is delayed, or the targeted invitation is dismissed.

### CROSS-REFERENCE TO RELATED APPLICATION

The present application is based on and claims the benefit of U.S. provisional patent application Ser. No. 62/409,553, filed Oct. 18, 2016, the content of which is hereby incorporated by reference in its entirety.

### BACKGROUND

Electronic (i.e., computer-based) trading systems, such as execution management systems, are trade tools that are used to create and execute trade orders on behalf of traders. Electronic trading systems are known to utilize trading algorithms as a lower cost and theoretically more efficient way to cope with various market inefficiencies and predatory trading behaviors. Such trading algorithms are typically designed to analyze market data, identify liquidity opportunities, and arrive at intelligent trading decisions.

Such trading systems can also operate to match buyers and sellers of a trade for given security to effectuate a trade of the security. This is typically accomplished through the matching of buy/sell trade criteria, such as the price and quantity of the security, for example.

### SUMMARY

Embodiments of the present disclosure relate to electronic or computerized trading systems, methods, and computer program products that operate to match opposing sides of a trade of a security. In a method of facilitating a trade of a security in an electronic trading system, a graphical user interface (GUI) is displayed on a display device of the system, and order characteristics are received from an offering member of the trading system through the GUI. In some embodiments, the order characteristics define a candidate order for a security. A selectable element is displayed on the GUI that creates a targeted invitation concerning the candidate order when selected. A selection of the selectable element by the offering member is received. A notification of the targeted invitation is then sent to one or more candidate members of the trading system in response to the selection of the selectable element. An answer to the notification is received from at least one of the candidate members. A trade of at least a portion of the candidate order is then executed between the offering member and at least one of the candidate members answering the notification, the execution of the candidate order is delayed (e.g., a candidate member requests additional time to consider the targeted invitation), or the targeted invitation is dismissed, in response to receiving the answer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified block diagram of an exemplary electronic trading system in accordance with embodiments of the present disclosure.

FIG. 2 is a simplified block diagram of an exemplary computing device in accordance with embodiments of the present disclosure.

FIG. 3 is a flowchart illustrating a method of facilitating a trade of a security using the electronic trading system, in accordance with embodiments of the present disclosure.

FIGS. 4-7 illustrate exemplary graphical user interfaces in accordance with embodiments of the present disclosure.

### DETAILED DESCRIPTION OF ILLUSTRATIVE EMBODIMENTS

Embodiments of the present disclosure relate to electronic or computerized trading systems, methods, and computer program products that operate to draw otherwise latent liquidity to an electronic trading system to facilitate matching and execution of a trade of a security. As used herein, the term “security” may refer to equity securities (e.g., stocks), debt or fixed income securities (e.g., bonds), or any other security type known in the art. In some embodiments, this matching occurs anonymously between qualified members of the electronic trading system, and for minimum quantities of the security, such as blocks of a security, e.g., 25,000 shares or $500,000 principal value. In some embodiments, the qualified members having recent contra activity and/or interest in the security are targeted by the system.

These and other embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, processors, and other components may not be shown, or shown in block diagram form, in order to not obscure the embodiments in unnecessary detail.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the description, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the present disclosure may be readily combined, without departing from the scope or spirit of the present disclosure.

It is understood that, although the terms first, second, etc. may be used herein to describe various elements, these elements should not be limited by these terms. These terms are only used to distinguish one element from another. Thus, a first element could be termed a second element without departing from the teachings of the present disclosure.

Unless otherwise defined, all terms (including technical and scientific terms) used herein have the same meaning as commonly understood by one of ordinary skill in the art relating to the present disclosure. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is appreciated by one of skill in the art that embodiments of the present disclosure may be embodied as methods, systems, devices, and/or computer program products, for example. Accordingly, embodiments of the present disclosure may take the form of an entirely software embodiment or an embodiment combining software and hardware aspects. The computer program or software aspect of embodiments of the present disclosure may comprise computer readable instructions or code stored in a computer readable medium or memory. Execution of the program instructions by one or more processors (e.g., central processing unit) results in the one or more processors performing one or more functions or method steps described herein. As used herein, information, program instructions and other data that is accessed, controlled, modified and or communicated by components of the electronic trading system may be stored in any suitable patent subject matter eligible computer readable media or memory including, for example, hard disks, CD-ROMs, optical storage devices, magnetic storage devices, or other suitable digital data storage devices. Such computer readable media or memory do not include transitory waves or signals.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure may also be described using flowchart illustrations and block diagrams. Although a flowchart may describe the operations as a sequential process, many of the operations can be performed in parallel or concurrently. In addition, the order of the operations may be re-arranged. A process is terminated when its operations are completed, but could have additional steps not included in a figure or described herein.

It is understood that one or more of the blocks (of the flowcharts and block diagrams) may be implemented by computer program instructions. These program instructions may be provided to a processor circuit, such as a microprocessor, microcontroller or other processor, which executes the instructions to implement the functions specified in the block or blocks through a series of operational steps to be performed by the processor(s) and corresponding hardware components.

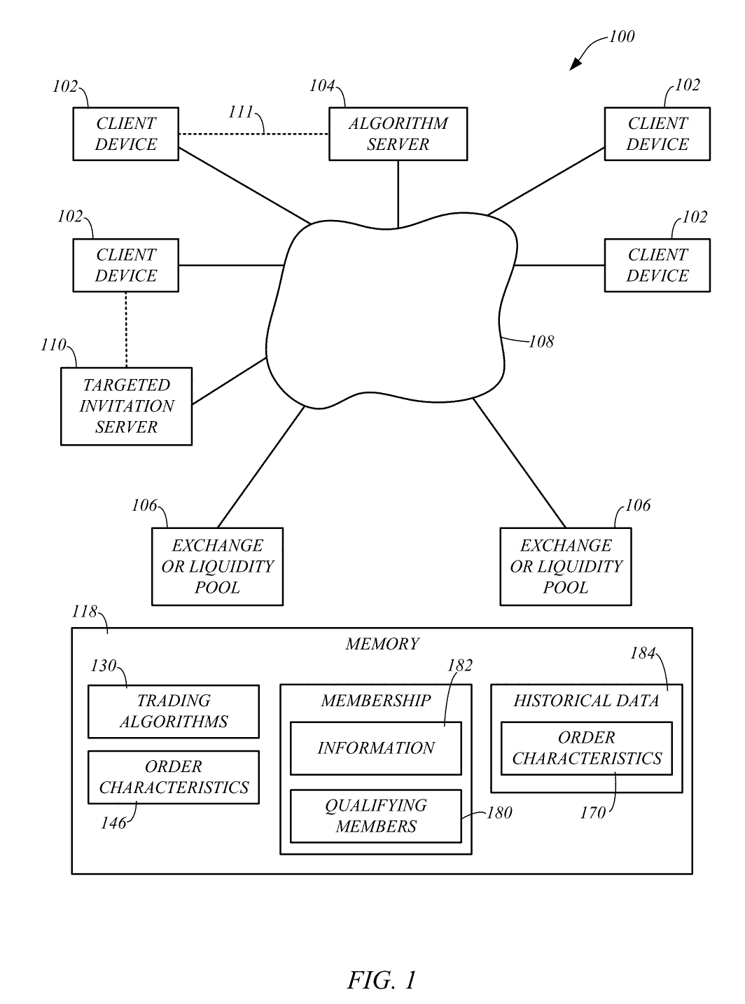

FIG. 1 is a simplified block diagram of an exemplary electronic or computerized trading system 100 in accordance with embodiments of the present disclosure. In some embodiments, the system 100 includes one or more client devices 102, one or more algorithm servers 104, and one or more exchanges/liquidity pools 106. Some embodiments of the algorithm server 104 facilitate the selection and implementation of one or more trading algorithms. In some embodiments, each algorithm server 104 is in communication with one or more of the exchanges/liquidity pools 106 using a suitable data communication protocol. In some embodiments, the one or more servers 104 may communicate with the exchanges/liquidity pools 106 through the network 108, or another suitable communication link.

In some embodiments, the term “exchange/liquidity pool” is broadly defined to include various trading venues or marketplaces, i.e., both lit and dark markets and liquidity pools, alternative trading systems (ATSs), electronic communication networks (ECNs), crossing networks, etc. As known in the art, a lit market generally operates by displaying market participants' orders to all other market participants, while orders (or indications of interest) are generally not displayed to participants in dark markets. In some embodiments, the system 100 processes information for a large number of users (e.g., at least 100; at least 500; at least 1,000; at least 10,000; at least 100,000; at least 1,000,000, etc.) and concurrent transactions (e.g., at least 100; at least 500; at least 1,000; at least 10,000; at least 100,000; at least 1,000,000, etc.).

In some embodiments, the system 100 includes a targeted invitation server 110. As described below in greater detail, embodiments of the targeted invitation server 110 are configured to target a qualified member of the system 100 that is determined by the system to be a potential match for filling the opposing side of a candidate trade order.

In some embodiments, each client device 102, such as a trader terminal, is in communication with one or more of the algorithm servers 104, and/or the targeted invitations server 110 via a suitable data communication protocol. In some embodiments, one or more of the client devices 102 communicate with one or more of the algorithm servers 104, and/or the targeted invitation server 110 through a network 108, or another suitable data communication link, such as a direct communication link represented by dashed line 111. In some embodiments, the client devices 102 are configured for data communication with one or more of the exchanges/liquidity pools 106, such as through the network 108, or another suitable data communication link, such as a direct communication link. In some embodiments, one or more of the algorithm servers 104 and/or the targeted invitation server 110 are included in one or more of the client devices 102.

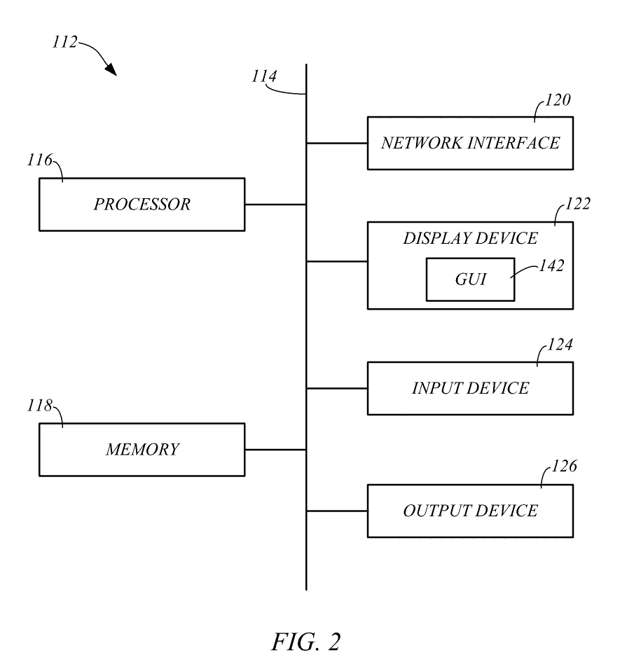

In some embodiments, each client device 102, each algorithm server 104, each of the exchanges/liquidity pools 106, and/or the targeted invitation server 110 include one or more computing devices 112, an example of which is illustrated in the simplified block diagram of FIG. 2. In some embodiments, each computing device 112 includes hardware components, such as, for example, a bus 114, a processor 116, memory 118, a network interface 120, a display device 122, an input device 124, an output device 126, and/or other computing device hardware components. Thus, each instance of the computing device 112 may include additional, different, or fewer components than those illustrated in FIG. 2.

In some embodiments, the processor 116 represents one or more microprocessors or central processing units, a single device or a combination of devices, such as associated with a network or distributed processing system. In some embodiments, the processor 116 may be programmed to perform the functions, acts, tasks, and/or method steps described herein through the execution of program code stored in the memory 118, and/or program code that is accessed by the processor 116 through the network interface 120, for example. In some embodiments, the processor 116 performs a suitable processing strategy, such as multi-processing, multi-tasking, parallel processing, and/or remote processing, for example. In some embodiments, such processing may be local or remote and may be moved from one processor to another processor.

In some embodiments, the memory 118 may be tangible computer readable media, such as that described above. The memory 118 may represent local memory to the computing device 112, or memory that is remote from the computing device 112, such as memory that is accessible over the network 108, for example. In some embodiments, the memory 118 may include a single device or multiple devices. For example, the memory 118 may include random access memory and hard drive storage. In some embodiments, the memory 118 may be adjacent to, part of, programmed with, networked with, and/or remote from processor 116 such that data stored in the memory 118 may be retrieved and processed by the processor 116. As mentioned above, in some embodiments, the memory 118 may store program instructions or code that are executable by the processor 116 to perform one or more of the acts or functions described herein. Thus, it is understood that method steps or other functions described herein include the performance of the method steps or functions in response to one or more processors 116 executing program code or instructions stored in one or more memory devices 118.

To simplify FIG. 1, the illustrated memory 118 represents one or more memory devices of the system 100, such as memory devices of the client devices 102, the algorithm server 104, the targeted invitation server 110, or other memory that is accessible by the client devices 102, the algorithm server 104, and/or the targeted invitation server 110. Thus, each of the programs and data stored in the memory 118 of FIG. 1 may be located in different memory devices, or the same memory device. Accordingly, in some embodiments, one or more of the data or programs stored in the memory devices represented by the memory 118 in FIG. 1 may be accessed by the client devices 102, the algorithm server 104, and/or the targeted invitation server 110 directly, accessed through the network 108, and/or accessed in another suitable manner. Accordingly, while specific data communication links between the memory 118 and the client devices 102, the algorithm server 104, the targeted invitation server 110, and the network 108 are not illustrated in FIG. 1, it is understood that such data communication links exist in some embodiments of the present disclosure.

In some embodiments, the display device 122 includes a visual output device (e.g., electronic display, electronic paper, flat panel display, light-emitting diode (LED) displays, etc.). In some embodiments, the display device 122 is adapted to display a graphical user interface (GUI), such as an interactive trading screen allowing, for example, one or more trading actions to be performed by a user through the trading screen. For example, an interactive trading screen or GUI may allow one or more order entry parameters to be set and/or sent using one or more order entry actions. In some embodiments, the display device 122 and/or input device 124 may be used to interact with the GUI. In some embodiments, the display device 122 includes an input device 124. In some embodiments, the computing device 112 may not include the display device 122. In some embodiments, the output device 126 is separate from the display device 122.

In some embodiments, the input device 124 includes a keyboard, a mouse, a microphone, a touch-screen, a trackball, a keypad, a joystick, and/or other suitable input device for providing input to the computing device 112. In some embodiments, the input device 124 may be used, for example, to provide command selections to the processor 116. For example, the input device 124 may be a mouse or touchpad that is used to control a cursor displayed on a GUI presented on the display device 122.

In some embodiments, trading algorithms 130 are stored in memory 118 that is accessible by the processor 116 of the algorithm server 104, such as the memory 118 of the computing device 112 that forms the algorithm server 104, for example, as illustrated in FIG. 1. Each of the trading algorithms 130 are computerized trading tools that implement models and strategies to complete security transactions within the parameters or order characteristics of the trade order within an open forum. Different trading algorithms utilize different models and parameters to implement unique trading strategies. For example, a trading algorithm 130 may be used to divide up a large block order into smaller orders that are easier to execute, or implement other trading strategies. In some embodiments, a selected algorithm 130 may have the ability to create a targeted invitation relating to an order to trade a security.

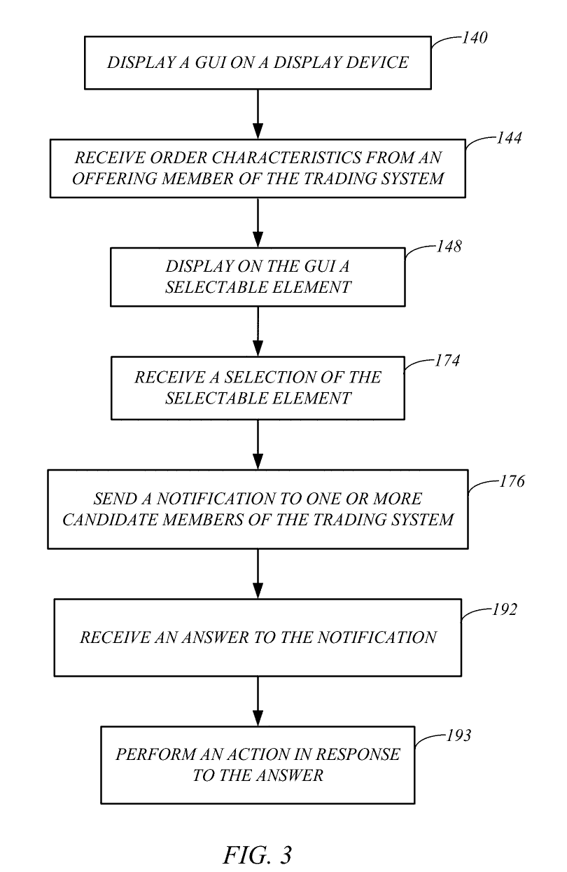

Embodiments of the targeted invitation server 110 facilitate targeting a qualified member of the system 100 that is determined by the system 100 to be a potential match for filling the opposing side of at least a portion of a candidate trade order. FIG. 3 is a flowchart illustrating a method of facilitating a trade of a security using the electronic trading system 100, in accordance with embodiments of the present disclosure, which may be performed using the targeted invitation server 110.

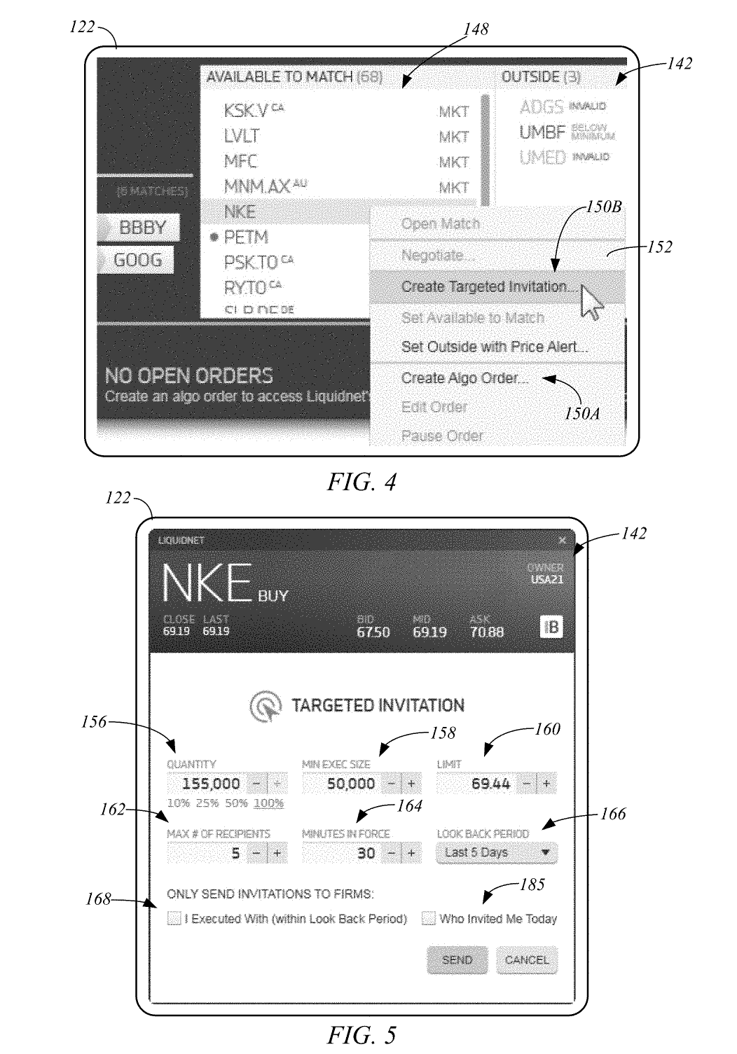

At 140 of the method, a graphical user interface (GUI) is displayed on a display device 122 of the system 100, as shown in FIG. 2. An exemplary GUI 142 in accordance with embodiments of the present disclosure is illustrated in FIG. 4. The GUI 142 may be presented in one or more windows, pop-up windows, or other visual elements on the display device 122. The display device 122 may be a component of a computing device 112 forming one of the client devices 102, for example, or other computing device 112 of the system 100.

At 144 of the method, one or more order characteristics 146 (FIG. 1) that define a candidate order for a security are received from an offering member of the system 100 through the GUI 142. Exemplary embodiments of the order characteristics 146 include an identification of the security to be traded, a target quantity of the security to be traded, a limit price for the security, an indication as to whether the order is on the buy or sell side, and/or other conventional order characteristics. In some embodiments, an offering user of the system 100 enters the one or more order characteristics through the GUI 142 presented on one of the client devices 102 or another computing device 112, for example. In some embodiments, the GUI 142 includes a display of textual and/or graphical elements relating to the order characteristics 146. In some embodiments, the elements may be used by the user to enter one or more of the candidate order characteristics. Thus, the elements may include data entry fields, drop-down menus, scrolling elements, and other conventional GUI elements for entering information. Exemplary GUI elements and other features include those described in U.S. patent application Ser. No. 15/198,695, filed Jun. 30, 2016, which is incorporated herein by reference in its entirety.

In one exemplary embodiment, the GUI 142 includes a list 148 of securities that are available for trading by the offering member, such as illustrated in the exemplary GUI 142 shown in FIG. 4. In some embodiments, the GUI 142 presents selectable elements, generally referred to as 150, that represent various options relating to one of the securities. For example, a pop-up menu 152 may be presented in the GUI 142, such as in response to an input received through an input device 124 (e.g., a right-click of a mouse) to present the selectable elements 150, for example. Other techniques for presenting the selectable elements 150 may also be used. The selectable elements 150 may be presented as buttons or other conventional selectable elements.

In some embodiments, the selectable elements 150 include a selectable element 150A that is used to execute an order using an algorithm 130 (referred to herein as an “algo order”). Here, selection of the element 150A generally causes the system 100 to access the algorithm server 104 where the user can enter the order characteristics and execute the order using one of the trading algorithms 130. This allows the order to be fulfilled in full or in portions by members of the system 100 and members of other trading systems, depending on the parameters of the selected trading algorithm 130. In some embodiments, an offering member may also enable the selected trading algorithm 130, at its discretion, to create a targeted invitation relating to the order, as described below.

In some embodiments, the selectable elements 150 include a selectable element 150B, the selection of which allows the offering member to create a targeted invitation. In some embodiments, the selection of the element 150B by the offering member triggers the GUI 142 to display a window for entering the order characteristics for the candidate order, as shown in the exemplary GUI 142 of FIG. 5. Thus, the offering member may use the GUI 142 of FIG. 5 to enter the order characteristics described above. Additionally, in some embodiments, the GUI 142 may include additional information regarding the selected security including order characteristics 146, as shown in FIG. 5. In some embodiments, the targeted invitation server 110 only presents the selectable element 150B, and/or only triggers the GUI 142 to display the window for entering the order characteristics for the targeted invitation, when candidate members exist that meet certain requirements, as described below.

In some embodiments of step 148, the GUI 142 allows the offering member to first create the candidate order by selecting the order characteristics 146, then presents the offering member with options as to how the order should be placed, such as using one of the algorithms 130 or through a targeted invitation. This can be accomplished, for example, by presenting corresponding selectable elements in the GUI 142 where the candidate order is generated, such as in a GUI 142 similar to that presented in FIG. 5. As noted above, in some embodiments, an offering member may select a trading algorithm 130 for a candidate order, and also enable the selected trading algorithm 130, at its discretion, to create a targeted invitation relating to the order.

In such cases, where a trading algorithm 130 with access to liquidity provided by members of a first trading system 100 can also route all or portions of a candidate order to one or more other external trading systems and/or execution venues, the trading algorithm 130 may apply certain guidelines in determining whether and when to create a targeted invitation and send a notification of the targeted invitation to qualified members of the first system 100. For example, in some embodiments, the trading algorithm 130 may only create a targeted invitation and send a targeted invitation notification to qualified members of the first system 100 for an algo order that can also route to other external trading systems and/or execution venues if the remaining order size of the associated order is at least two (2) times a minimum execution size for targeted invitations, as determined by trading system 100.

In other embodiments, the trading algorithm 130 may only send a targeted invitation notification for an algo order that can route to external trading systems until a given time, e.g., zero to ten (10) minutes, has elapsed after the offering member's instruction authorizing the algorithm to send a targeted invitation to qualifying members of the first system 100. In some embodiments this time period is six (6) minutes.

In alternate embodiments, where a trading algorithm 130 can also route all or portions of a candidate order to one or more other external trading systems and/or execution venues, the trading algorithm 130 will not automatically create a targeted invitation. Instead, the algorithm will estimate the quantity that the algo order will execute externally over a period of time and the expected remaining quantity for the algo order over that time period. If the expected remaining quantity for the algo order after a pre-determined period of time will be below the pre-determined minimum execution size for targeted invitations, the algorithm will not create a targeted invitation directed at qualifying members of the first trading system 100.

In some embodiments, the GUI 142 facilitates the entry of values for various order characteristics 146, such as for a total quantity 156 of the security, a minimum execution size 158 for the order, a limit price 160 for the security, and other order characteristics 146. In some embodiments, the limit price is restricted to be at or above a current mid-price in the case of a buy candidate order, or at or below the current mid-price in the case of a sell candidate order, for the order to qualify for a targeted invitation. The minimum execution size 158 may be subject to certain minimum thresholds expressed in shares, value, and/or a percentage of average daily volume traded (ADV), e.g., 25,000 shares, $100,000, 15% ADV.

In some embodiments, the GUI 142 may present data entry elements for entry of such values of the order characteristics in any suitable manner, such as drop-down menus, data entry windows, incrementally adjustable values (as shown), or other suitable data entry elements.

In some embodiments, the GUI 142 presents data entry elements for order characteristics 146 that are specific to the targeted invitation, such as a maximum number of recipients 162, a time period 164, a look-back period 166, and/or other order characteristics 146 that are specific to the targeted invitation. The maximum number of recipients 162 relates to the maximum number of candidate members to send the targeted invitation to. In some embodiments, the time period 164 represents the time period during which the target invitation server 110 may send out the targeted invitation, or the amount of time the recipient or recipients of the targeted invitation will have to act on the targeted invitation. The look-back period 166 defines a period of time that the targeted invitation server 110 reviews historical data of security transactions and trading interest involving the members of the electronic trading system 100 to identify candidate members that may be interested in transacting in the security.

Exemplary embodiments of the options for the look-back period 166 include a current trading day and the preceding trading day, a current trading day and at least the 5 preceding trading days, a current trading day and at least the 10 preceding trading days, a current trading day and at least the 15 preceding trading days, a current trading day and at least the 20 preceding trading days, a current trading day and at least the 25 preceding trading days, a current trading day and at least the 30 preceding trading days, a current trading day and at least the 45 preceding trading days, a current trading day and at least the 60 preceding trading days, and/or a current trading day and at least the 90 preceding trading days. Other look-back periods 166 may also be used.

In some embodiments, the GUI 142 presents the offering member with options of limiting the candidate members to those with whom the offering member executed a security transaction, such as, for example, within the look-back period, as indicated at 168. In some embodiments, the GUI 142 presents the offering member with options of limiting the candidate members to those from whom the offering member received a targeted invitation within a specified period of time, such as, for example, within the current day (as shown), within the look-back period, or within another period, as indicated at 185.

In some embodiments of the method, the targeted invitation server 110 receives a selection of the selectable element 150B of the GUI 142 or other indication from the offering member that the targeted invitation should be created, as indicated at 174 (FIG. 3). In response to 174, the targeted invitation server 110 sends a notification to one or more candidate members of the electronic trading system, at 176.

In some embodiments, the candidate members that are eligible to receive a targeted invitation are selected from a group of qualifying members, which is a subset of the members of the electronic trading system 100. In some embodiments, the memory 118 includes a listing of the qualified members 180, as shown in FIG. 1. The qualifying members may be individuals and/or trading firms that use the electronic trading system 100. In some embodiments, the qualifying members are required by the system 100 to opt in to send and receive targeted invitations.

In some embodiments, qualifying members only qualify in the regions (e.g., U.S., Europe, etc.) in which they actively trade. In some embodiments, if the activities of a member in one region result in the member becoming a qualifying member, the member is also designated as a qualifying member in the other regions in which the member actively trades.

In some embodiments, the targeted invitation server 110 reviews membership information 182, and determines whether the member information for each of the members meets one or more threshold criterion. The targeted invitation server 110 then identifies the members whose membership information 182 meets the one or more threshold criterion as qualifying members. In some embodiments, historical data 184 corresponding to the members is used as the membership information 182, such as order characteristics (i.e., the security traded, the price, the quantity, etc.) 170 from previously placed trade orders that were fully executed, partially executed, or cancelled, for example.

In some embodiments, the one or more threshold criterion includes an average daily liquidity threshold. In some embodiments, the average daily liquidity threshold relates to the value of the trade orders available for matching by the member within the system 100. In some embodiments, completed and/or open orders placed by the member are used to assess the average daily liquidity of the member. In some embodiments, the average daily liquidity of a member is evaluated over a predetermined period of time, such as the last two quarters, the last year or less, the last 9 months or less, the last 6 months or less, and/or the last 3 months or less, for example.

In some embodiments, the average daily liquidity threshold can be set to any desired value. In some exemplary embodiments, the average daily liquidity threshold is set as greater than 10 million US dollars, greater than 50 million US dollars, and/or greater than 100 million US dollars.

In some embodiments, the one or more threshold criterion includes a number of qualifying transactions performed by the member within a predetermined time period. In some embodiments, this relates to a positive action rate of the member, which relates to the rate at which a member responds to bona-fide opportunities to trade on the system, e.g., matches with other members. Thus, the positive action rate can be viewed as an indication of whether a member is using the trading system in accordance with system protocols, and, therefore, will be likely to also respond to targeted invitations in an effective manner. Repeated failure to respond to targeted invitations may result in a member being disqualified from sending or receiving targeted invitations. In some embodiments, the predetermined time period over which the qualifying transactions are counted and the positive action rate is determined is the last two quarters, the last year or less, the last 9 months or less, the last 6 months or less, and/or the last 3 months or less, for example.

In some embodiments, the candidate members for a given targeted invitation are selected by the targeted invitation server 110 from the qualifying members 180 based on one or more criterion. The offering member may be notified if the targeted invitation server 110 determines that there are no candidate members for a given targeted invitation.

In some embodiments, qualifying members who have been on a side of an order for the security of the targeted invitation are identified as candidate members. In some embodiments, only the qualifying members 180 that were on the opposing side of the order from that of the offering member are identified as candidate members. That is, when the offering member of the targeted invitation is selling a security, only the qualifying members who have shown an interest in buying the security based on the historical data 184 are identified as candidate members for the targeted invitation. In some embodiments, this evaluation of the qualifying members requires the qualifying member to have been involved with the trade of, or to have demonstrated an interest to trade, a predetermined minimum quantity of the security, such as, for example, the minimum execution quantity 158 set by the offering member (FIG. 5). In some embodiments, this evaluation of the qualifying members is limited to a predetermined period of time, such as within the look-back period described above.

In some embodiments, candidate members of the qualifying members 180 are limited to the members who had previously sent a targeted invitation to the offering member. In some embodiments, this requirement may be designated by the offering member using, for example, the GUI 142 of FIG. 5 by selecting element 185. In some embodiments, only the qualifying members that sent a targeted invitation to the offering member within a predetermined period of time are potential candidate members. Exemplary embodiments of the predetermined period of time include: the current day, the current day and the previous day, the current day and the previous 2 days, the current day and the previous 3 days, the current day and/or the previous 5 days.

In some embodiments, qualifying members 180 who demonstrated recent interest in transacting on the same side for the security as the offering member are disqualified as candidate members. In some embodiments, this is limited to trading interest or transactions that occurred within a predetermined period of time prior to the creation of the targeted invitation. For example, a qualifying member may be ineligible to receive a targeted invitation notification in a given security if the qualifying member expressed same-side interest (e.g., via an executed trade or indication of interest) in the security during a pre-determined look-back period (e.g., the shorter of the 20 prior trading days and the specified look-back period) on a more recent trading day than, or the same trading day as, the qualifying member's most recent opposite-side interest in that security.

In some embodiments of the method, the targeted invitation server 110 sends the targeted invitation to no more than the maximum number of candidate members designated by the order characteristics 146, such as designated by element or entry 162 of the GUI 142 of FIG. 5, for example.

In some embodiments of the method, the targeted invitation server 110 prioritizes the candidate members for the targeted invitation, and only sends the targeted invitation to the highest priority candidates. The priority of the candidates may be evaluated in any suitable manner. In some embodiments, the priority of the candidates is established based on their positive action rate, their average daily volume, and/or other factors.

In some embodiments, the targeted invitation server 110 limits the period of time during which it sends the targeted invitation to the candidate members based on the period 164 (FIG. 5) set by the offering member.

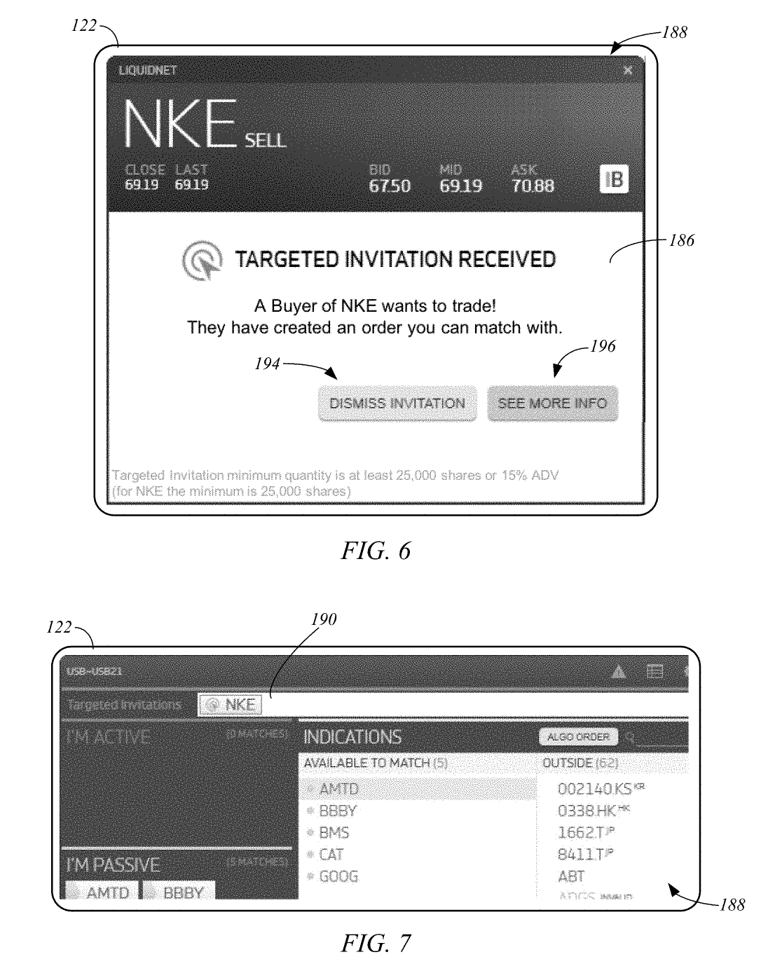

In some embodiments of step 176 of the method, the notification sent to the one or more candidate members by the targeted invitation server 110, notifies them of the trade offer defined by the order characteristics 146 using any suitable technique. In some embodiments, notification by the targeted invitation server 110 generates a pop-up window within a GUI of the client device of the one or more candidate members. FIG. 6 shows an exemplary notification in the form of a pop-up window 186 that may be presented within a GUI 188 of the client device 102 of a candidate member, such as on a display device 122, for example. In some embodiments, the notification includes a tile 190 displayed within a GUI 188 of the client display device 122 that presents the targeted invitation to the candidate user, such as shown in FIG. 7. In some embodiments, the notification provides the recipient candidate member with information about the security trade including some of the order characteristics 146, as shown in FIGS. 6 and 7. In some embodiments of step 176 of the method, provided there is at least one candidate member identified by targeted invitation server 110, an actionable, i.e., firm, order available for matching and execution against any member of the trading system—not just qualified members or recipient candidate members identified by the targeted invitation server 110—is created and remains in effect for as long as the targeted invitation is valid.

In some embodiments of the method, the targeted invitation server 110 receives an answer to the notification, at 192 (FIG. 3), and the targeted invitation server 110 performs an action in response to the answer, at 193. In some embodiments, the notification within the GUI 188 includes one or more selectable elements that provide the candidate member with options for responding. In some embodiments, the notification includes selectable elements in the GUI that can be selected by the candidate member to dismiss the offer (e.g., selectable element 194), retrieve more information about the offer (e.g., selectable element 196), accept the candidate order, create an order (or indication) in response to the candidate order, or provide other options for the candidate member. In some embodiments, the selection of one of the selectable elements of the notification sends the corresponding answer to the targeted invitation server 110. For example, if the user dismisses the targeted invitation by, for example, selecting the element 194, the client device 102 may send a notification to the targeted invitation server 110 indicating such, and the targeted invitation server 110 may cancel the candidate order at step 193. The offering member may be notified if all recipient candidate members dismiss the targeted invitation.

If the user selects the element 196, additional windows may be presented in the GUI 188 that provide the candidate member with additional information concerning the candidate order, e.g., minimum execution size. If the candidate member wishes to accept the targeted invitation, the candidate member may then create an opposite-side order (or indication) that will match against the candidate order. If the answer received by the targeted invitation server 110 indicates that the candidate order is accepted, the targeted server 110 executes or processes the candidate order between the offering member and the candidate member to complete the trade in step 193. If the answer received by the targeted invitation server 110 indicates that the candidate order is delayed, i.e., a candidate member has requested additional time to consider and respond to the targeted invitation, the targeted invitation server 110 can, in step 193, notify the offering member of the delay, and provide the offering member an option to accept or decline the proposed delay. If the offering member accepts the request for additional time from the candidate member, and the candidate member creates a matching order (or indication) during or after expiration of the delay, the candidate order may execute against the matching order submitted by the candidate members.

Additional embodiments of the present disclosure are directed to a computer program stored in memory that, when executed by a processor, such as that represented by the targeted invitation server 110, performs one or more steps of the method of FIG. 3. Some embodiments of the present disclosure are directed to an electronic or computerized trading system 100 including one or more components, such as the targeted invitation server 110, that are configured to perform one or more steps of the method of FIG. 3. Additional embodiments are directed to an electronic or computerized trading system 100 in accordance with one or more embodiments described herein.

Although the embodiments of the present disclosure have been described with reference to preferred embodiments, workers skilled in the art will recognize that changes may be made in form and detail without departing from the spirit and scope of the present disclosure.

What is claimed is:

1. A method of facilitating a trade of a security in an electronic trading system, the method comprising:
displaying a graphical user interface (GUI) on a display device of the system;
receiving order characteristics from an offering member of the trading system through the GUI, the order characteristics defining a candidate order for a security;
displaying on the GUI a selectable element that creates a targeted invitation concerning the candidate order when selected;
receiving a selection of the selectable element by the offering member;
sending a notification of the targeted invitation to one or more candidate members of the trading system in response to the selection of the selectable element;
receiving an answer to the notification from at least one of the candidate members; and
performing one of executing a trade of at least a portion of the candidate order between the offering member and at least one of the candidate members, delaying the candidate order, and dismissing the targeted invitation, in response to receiving an answer.

2. The method according to claim 1, further comprising:
identifying a subset of the members of the trading system as qualified members; and
identifying the one or more candidate members from the qualified members.

3. The method according to claim 2, wherein identifying a subset of the members of the trading system as qualified members comprises:
analyzing member information of each of the members of the trading system stored in a computer-readable medium;
determining whether the member information for each of the members meets one or more threshold criterion; and
identifying each of the members whose member information meets the one or more threshold criterion as a qualified member.

4. The method according to claim 3, wherein the one or more threshold criterion includes an average daily liquidity threshold, which relates to a total value of orders available for matching by the member within a predetermined period of time.

5. The method according to claim 4, wherein the total value is selected from the group consisting of greater than 10 million dollars, greater than 50 million dollars, and greater than 100 million dollars.

6. The method according to claim 4, wherein the predetermined period of time is selected from the group consisting of the last year or less, the last 9 months or less, the last 6 months or less, and/or the last 3 months or less.

7. The method according to claim 3, wherein the one or more threshold criterion includes a number of qualifying transactions performed by the member within a predetermined time period.

8. The method according to claim 2, wherein:
the offering member is on an offer side of the candidate order selected from the group consisting of a buy side or a sell side; and
identifying the one or more candidate members from the qualified members comprises identifying the qualifying members that have been on the side of an order for the security that is opposite the offer side.

9. The method according to claim 8, wherein identifying the one or more candidate members from the qualified members comprises identifying the qualifying members that have been on a side of an order for the security within a look-back period selected from the group consisting of a current trading day, a current trading day and the preceding trading day, a current trading day and at least the 5 preceding trading days, a current trading day and at least the 10 preceding trading days, a current trading day and at least the 15 preceding trading days, a current trading day and at least the 20 preceding trading days, a current trading day and at least the 25 preceding trading days, a current trading day and at least the 30 preceding trading days, a current trading day and t at least the 45 preceding trading days, a current trading day and at least the 60 preceding trading days, a current trading day and at least the 90 preceding trading days.

10. The method according to claim 9, wherein the look-back period corresponds to a period of time where the candidate member was last interested in trading a minimum quantity of the security that meets a quantity threshold.

11. The method according to claim 10, wherein the order characteristics include one of a designation of the look-back period and the minimum quantity.

12. The method according to claim 2, further comprising creating an actionable order that is available for execution against any member of the electronic trading system.

13. The method according to claim 3, wherein the one or more threshold criterion includes a targeted invitation sent from the candidate member to the offering member.

14. The method according to claim 2, further comprising disqualifying qualified members that expressed interest in trading the security on a same side as the offering member within a disqualifying period selected from the group consisting of the current trading day, a prior trading day, 2-5 days prior to the current trading day, 6-10 days prior to the current trading day, 11-15 days prior to the current trading day, and 16-20 days prior to the current trading day.

15. The method according to claim 1, wherein the order characteristics include a limit price, and the GUI restricts the limit price to be at or above a current mid-price in the case of a buy candidate order, or at or below the current mid-price in the case of a sell candidate order.

16. The method according to claim 15, further comprising notifying the one or more candidate members if the limit price is above the current mid-price in the case of a sell candidate order or below the current mid-price in the case of a buy candidate order.

17. The method according to claim 1, wherein:
the order characteristics include a maximum number of candidate members; and
sending a notification to one or more candidate members comprises sending the notification to no more than the maximum number of candidate members.

18. The method according to claim 17, further comprising prioritizing the candidate members, and sending a notification comprises sending a notification to up to the maximum number of the highest priority candidate members.

19. The method according to claim 1, wherein the order characteristics include a time-in-force parameter designating a period during which the targeted invitation remains actionable.

20. A method of facilitating a trade of a security in an electronic trading system, the method comprising:
displaying a graphical user interface (GUI) on a display device of the system;
receiving order characteristics from an offering member of the trading system through the GUI, the order characteristics defining a candidate order for a security;
displaying on the GUI a selectable element that enables a trading algorithm to create a targeted invitation concerning the candidate order when selected;
receiving a selection of the selectable element by the offering member;
sending a notification of the targeted invitation to one or more candidate members of the trading system in response to the selection of the selectable element using the trading algorithm;
receiving an answer to the notification from at least one of the candidate members; and
performing one of executing a trade of at least a portion of the candidate order between the offering member and at least one of the candidate members, delaying the candidate order, and dismissing the targeted invitation, in response to receiving an answer.
